(19) United States
(12) Patent Application Publication
(10) Pub. No.: US 2009/0278650 A1
(43) Pub. Date: Nov. 12, 2009

(54) INDUCTOR

(76) Inventor: Ming-Ming SHIEH, Taipei City 114 (TW)

Correspondence Address: HDLS Patent & Trademark Services, P.O. BOX 220746, CHANTILLY, VA, 20153-0746, US

(21) Appl. No.: 12/118,847

(22) Filed: May 12, 2008

(51) Int. Cl. H01F 5/04

(52) U.S. Cl. 336/200

(57) ABSTRACT

An inductor includes a casing, a coil and a core. The casing is provided with a slot. The coil is constituted of a first terminal, a bottom ring, a top ring and a second terminal. The first terminal is formed into a T-shaped strip and is partially inserted into the slot. The bottom ring wraps from a distal end of the first terminal. The top ring wraps from the distal end of the bottom ring and is overlapped on the bottom ring. The distal end of the top ring is bent downwardly to be located at the outside of the bottom ring. The second terminal extends from the distal end of the top ring and is partially inserted into the slot. The shape of the second terminal is the same as that of the first terminal. All of the first terminal, the bottom ring and the top ring have the same cross-sectional area. The core penetrates the coil and is accommodated in the casing.

### BACKGROUND OF THE INVENTION

1. Field of the Invention

The present invention relates to an electronic element, and in particular to an inductor.

2. Description of Prior Art

An inductor is also referred to as a coil, which is a passive element that is capable of resisting any change in electric current. The inductor is made by means of wrapping a lead around a core. The core can be made of magnetic or non-magnetic materials. The inductor is an electronic element that is capable of generating a change in magnetic flux via the change in the electric current of the coil and is made based on the principle of magnetic field. The source of the magnetic field derives from running electric charges. An alternating electric current can generate a magnetic field, and a variable magnetic field induces an electric current. The linear relationship between the magnetic field and the electric current is called inductance.

The inductor made by wrapping a lead has a self-induction effect, while the inductor made by wrapping more than one leads has a mutual-induction effect. The function of the inductor is to filter out the noises in the electric current, stabilize the electric current in a circuit, and prevent the interference caused by electromagnetic waves. The function of the inductor is similar to that of a capacitor and is also capable of storing and releasing the electric energy in the circuit so as to regulate the stability of the electric current. However, the capacitor stores the electric energy in the form of an electric field (electric charges) while the inductor stores the electric energy in the form of a magnetic field.

The electric field can be transformed into the magnetic filed and vice versa. When an electric current flows through a lead, the periphery of the lead will generate a magnetic field. On the contrary, if a coil intersects a magnetic line of force, an electric current will be generated in the coil. The inductor is made by means of wrapping a lead in such a manner that the respective windings of the lead are close to each other. When an electric current flows through the inductor, magnetic energy will be induced in the inductor. When the electric current becomes smaller, the magnetic energy within the coil will generate a force to block the electric current from changing.

As shown in FIG. 1, the conventional inductor is constituted of a casing 10a, a coil 20a and a core 30a. The casing 10a is provided with an accommodating chamber 11a. Both sides of the casing 10a are provided respectively with a hole 12a in communication with the accommodating chamber 11a. The coil 20a is accommodated in the accommodating chamber 11a. The coil 20a includes a first terminal 21a, a plurality of rings 22a wrapping from a distal end of the first terminal 21a and overlapping with each other, and a second terminal 23a connected to the ring 22a. The first terminal 21a and the second terminal 23a are made flat by means of punching and penetrate through the two holes 12a respectively to be located on both sides of the casing 10a. The core 30a is disposed in the coil 20a and accommodated in the accommodating chamber 11a. Via the above arrangement, an inductor can be obtained. Finally, the first terminal 21a and the second terminal 23a of the inductor are soldered on a circuit board 40a.

However, in practice, the above inductor has drawbacks as follows. Since the first terminal 21a and the second terminal 23a are made flat by punching, the cross-sectional areas in every portion of the first and second terminals 21a, 23a are different from each other. Further, the cross-sectional area of each terminal is also different from that of the ring 22a. As a result, the electric current flowing through the coil 20a will be unstable. Further, the first and second terminals 21a, 23a located on both sides of the casing 10a and soldered on the circuit board 40a will occupy additional space on the circuit board 40a. Moreover, since only the first and second terminals 21a and 23a are soldered to the circuit board 40a, the thus-formed inductor is not firmly fixed on the circuit board.

According to the above, in order to overcome the drawbacks of prior art, the inventor proposes the present invention based on his deliberate research and expert experience.

### SUMMARY OF THE INVENTION

In view of the above, the present invention is to provide an inductor. With the first and second terminals being partially inserted into slots on the bottom of the casing, the terminals occupy less space on the circuit board.

The present invention provides an inductor. With the first terminal, the second terminal, the bottom ring and the top ring having the same cross-sectional area, the effect of stabilizing electric current can be enhanced.

The present invention provides an inductor. With the first and second terminals being formed into a T-shaped strip and partially inserted into the slots on the bottom of the casing, the inductor can be fixed on the circuit board firmly.

The present invention provides an inductor, which is constituted of a casing, a coil and a core. The casing is provided with a slot. The coil is constituted of a first terminal, a bottom ring, a top ring and a second terminal. The first terminal is formed into a T-shaped strip and is partially inserted into the slot. The bottom ring wraps from a distal end of the first terminal. The top ring wraps from the distal end of the bottom ring and is overlapped on the bottom ring. The distal end of the top ring is bent downwardly to be located at the outside of the bottom ring. The second terminal extends from the distal end of the top ring and is partially inserted into the slot. The shape of the second terminal is the same as that of the first terminal. All of the first terminal, the bottom ring and the top ring have the same cross-sectional area. The core penetrates the coil and is accommodated in the casing.

### BRIEF DESCRIPTION OF THE DRAWINGS

FIG. 1 is a cross-sectional view showing the structure of a conventional inductor;

FIG. 2 is a schematic view showing the first embodiment of the present invention;

FIG. 3 is a cross-sectional view showing the assembled state of the present invention along the line 3-3 in FIG. 2;

FIG. 4 is a schematic view showing the second embodiment of the present invention;

FIG. 5 is a schematic view showing the third embodiment of the present invention;

FIG. 6 is a schematic view showing the fourth embodiment of the present invention; and

FIG. 7 is a schematic view showing the fifth embodiment of the present invention.

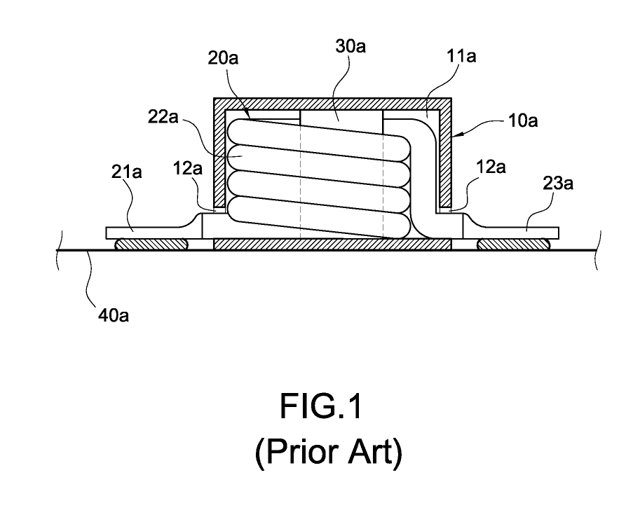

### DETAILED DESCRIPTION OF THE INVENTION

Several aspects of the present invention will be described with reference to preferred embodiments thereof and accompanying drawings. However, it should be understood that the drawings are illustrative only but not used to limit the scope of the present invention.

### First Embodiment

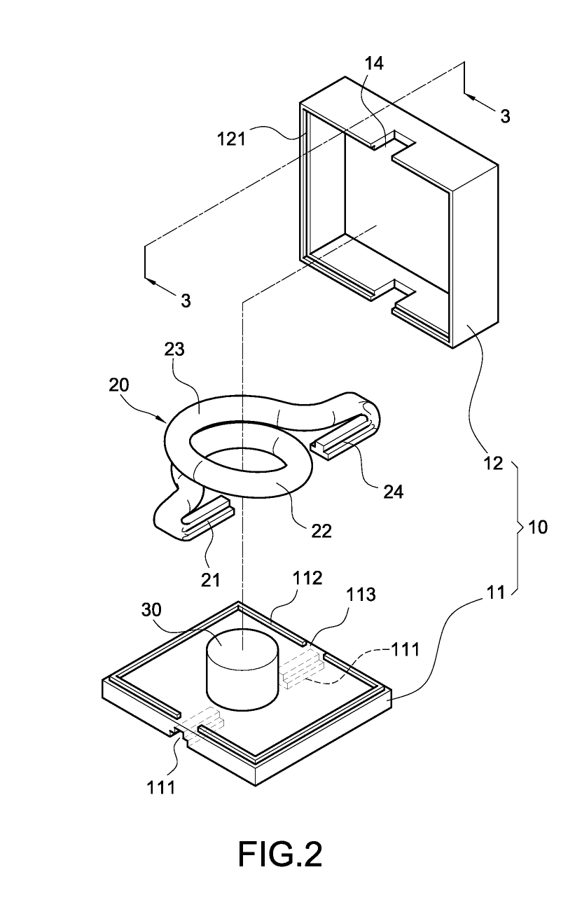

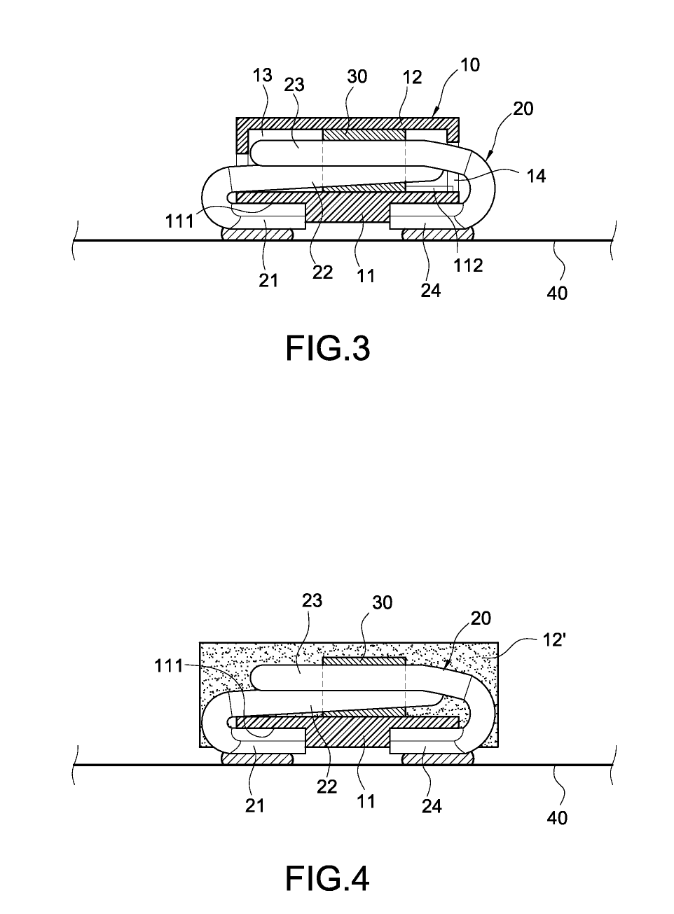

Please refer to FIG. 2 and FIG. 3. The inductor of the present invention is constituted of a casing 10, a coil 20 and a core 30.

The casing 10 comprises a bottom plate 11 and a cover plate 12 provided on the bottom plate 11. An accommodating chamber 13 is formed between the bottom plate 11 and the cover plate 12. Both sides of the cover plate 12 are provided with a hole 14 in communication with the accommodating chamber 13. The bottom plate 11 is provided with a slot 111 and has a buckling strip 112. The cover plate 12 is provided with a buckling groove 121. The buckling strip 112 can be buckled on the buckling groove 121. The buckling strip 112 can be a hook, while the buckling groove 121 can be a locking groove. Further, the holes 14 can be formed into a rectangular hole, while the slot 111 can be formed into a T-shaped elongate slot.

The coil 20 is made by wrapping a lead. The coil 20 comprises a first terminal 21, a bottom ring 22, a top ring 23 and a second terminal 24. The first terminal 21 is formed into a T-shaped strip and the cross-sectional area of every portion of the first terminal is the same. The first terminal penetrates through one of the holes 14 and is bent downwards and inwards to be partially inserted into the slot 111, so that the first terminal 21 can be connected on the bottom plate 11 firmly. The bottom ring 22 wraps from the distal end of the first terminal 21, and the cross-sectional area of every portion of the bottom ring is the same. The top ring 23 wraps from the distal end of the bottom ring 22 and is overlapped on the bottom ring 22. The distal end of the top ring 23 is bent downwards to be located at the outside of the bottom ring 22. The bottom ring 22 and the top ring 23 are arranged concentrically. The second terminal extends from the distal end of the top ring 23 and penetrates the other hole 14 to be partially inserted into the slot 111. The shape of the second terminal is the same as that of the first terminal 21. All of the first terminal 21, the bottom ring 22 and the top ring 23 have the same cross-sectional area. Further, the first terminal 21 and the second terminal 24 are located in the same plane and thus can be soldered on a circuit board 40.

The core 30 penetrates the coil 20 and is accommodated in the accommodating chamber 13. The core 30 can be formed into a cylindrical body. Further, the core 30 can be integrally formed with the bottom plate 11.

Please refer to FIG. 2 and FIG. 3 again, in assembly, the bottom ring 22 and the top ring 23 of the coil 20 are connected in the coil 30 of the bottom plate 11 with the first and second terminals 21, 24 being positioned in a positioning slot 113 formed by the buckling strip 112 respectively. Then, the cover plate 12 is covered on the bottom plate 11, so that the coil 20 and the core 30 can be accommodated in the accommodating chamber 13. In this way, the first and second terminals 21, 24 penetrate through the two holes 14 respectively and are bent downwards and inwards to be partially inserted in the slot 111. Since the first and second terminals 21, 24 are formed into a T-shaped strip and are partially inserted into the slot 111 of the bottom plate 11, the present invention can be firmly fixed on the circuit board 40 after soldering. Further, since the first and second terminals 21, 24 are located on the bottom of the bottom plate 11, the terminals occupy less space on the circuit board 40.

When the present invention is in use, the first and second terminals 21, 24 of the coil 20 are soldered to the circuit board 40 or other electronic elements. After the present invention is supplied with electricity, the casing 10 can prevent the magnetic lines of force generated by the coil 20 from being exposed to the outside so as to cause electromagnetic interference to the circuit board 40 or the electronic element. On the other hand, the casing 10 can protect the present invention against the electromagnetic interference caused by other electronic elements. Further, since all of the first terminal 21, the second terminal 24, the bottom ring 22 and the top ring 23 have the same cross-sectional area, the effect of stabilizing electric current can be enhanced.

### Second Embodiment

Please refer to FIG. 4, which shows the second embodiment of the present invention. The difference between the present embodiment and the first embodiment lies in that the cover plate 12′ covers the core 30, the bottom ring 22 and the top ring 23 and a portion of the bottom plate 11 via an injection-molding process. In this way, the magnetic lines of force generated by the coil 20 can be prevented from being exposed to the outside, and the present invention can be protected against the electromagnetic interference caused by other electronic elements.

### Third Embodiment

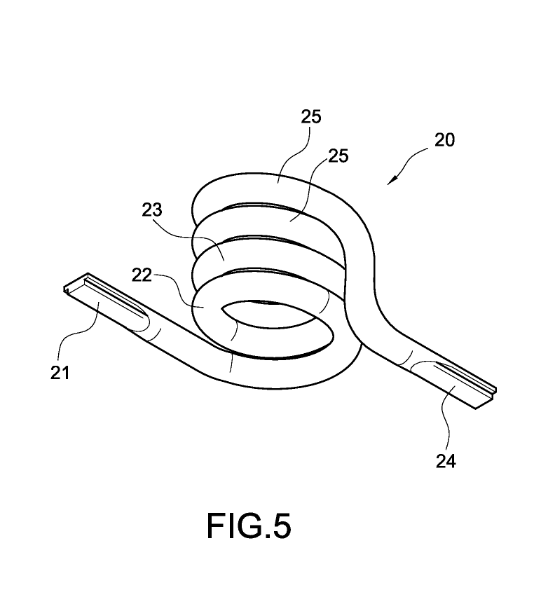

Please refer to FIG. 5, which shows the third embodiment of the present invention. The difference between the present embodiment and the first embodiment lies in that, in addition to the bottom ring 22 and the top ring 23, the coil 20 further comprises a plurality of first rings 25 wrapping from the distal end of the top ring 23. These first rings 25 are overlapped on the top ring 23.

### Fourth Embodiment

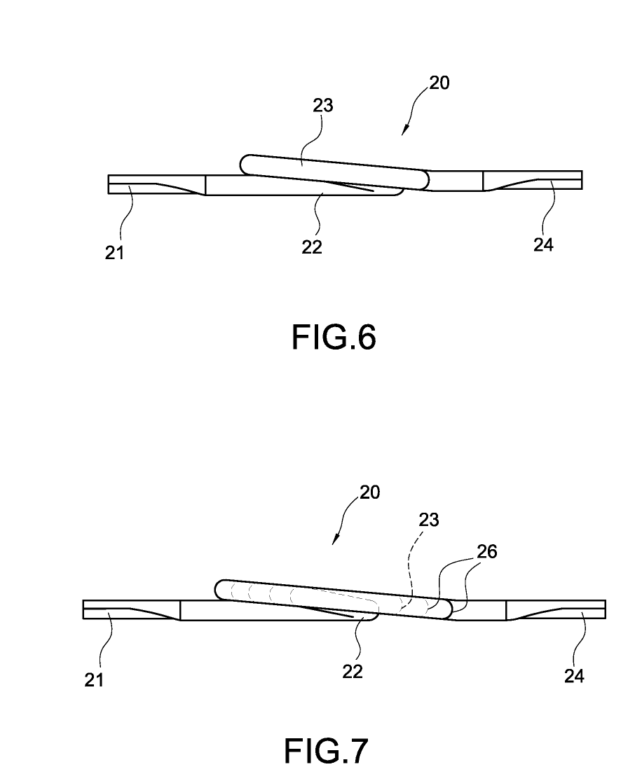

Please refer to FIG. 6, which shows the fourth embodiment of the present invention. The difference between the present embodiment and the first embodiment lies in that the top ring 23 of the coil 20 is formed on the outer periphery of the bottom ring 22 and extends upwardly and obliquely. Further, the bottom ring 22 is arranged to be eccentric to the top ring 23.

### Fifth Embodiment

Please refer to FIG. 7, which shows the fifth embodiment of the present invention. The difference between the present embodiment and the fourth embodiment lies in that, in addition to the bottom ring 22 and the top ring 23, the coil 20 further comprises a plurality of second rings 26 wrapping from the distal end of the top ring 23. These second rings 26 wrap around the outer periphery of the top ring 23. These second rings 26 are arranged to be eccentric to each other.

According to the above, the present invention really achieves the desired objects and solves the drawbacks of prior art. Further, the present invention indeed has novelty and inventive steps, and thus conforms to the requirements for a utility model patent.

What is claimed is:

1. An inductor, comprising:
a casing provided with a slot;
a coil comprising:
a first terminal formed into a T-shaped strip and partially inserted into the slot;
a bottom ring wrapping from a distal end of the first terminal;
a top ring wrapping from a distal end of the bottom ring and overlapped on the bottom ring, the distal end of the top ring being bent downwardly to be located at the outside of the bottom ring; and
a second terminal extending from the distal end of the top ring and partially inserted into the slot, the shape of the second terminal being the same as that of the first terminal, all of the first terminal, the bottom ring and the top ring having the same cross-sectional area; and
a core disposed in the coil and accommodated in the casing.

2. The inductor according to claim 1, wherein the casing comprises a bottom plate and a cover plate provided on the bottom plate.

3. The inductor according to claim 2, wherein the cover plate covers the core and the rings.

4. The inductor according to claim 2, wherein an accommodating chamber is formed between the bottom plate and the cover plate, both sides of the cover plate are provided with a hole in communication with the accommodating chamber, the rings and the core are accommodated in the accommodating chamber, and the terminals penetrate through the holes respectively.

5. The inductor according to claim 2, wherein the bottom plate is provided with a buckling strip, the cover plate is provided with a buckling groove, and the buckling strip is buckled into the buckling groove.

6. The inductor according to claim 1, wherein the slot is formed into a T-shaped slot.

7. The inductor according to claim 1, wherein the bottom ring and the top ring are arranged concentrically.

8. The inductor according to claim 1, wherein the top ring is formed on the outer periphery of the bottom ring and extends downwardly and obliquely.

9. The inductor according to claim 8, wherein the bottom ring and the top ring are arranged to be eccentric to each other.

10. The inductor according to claim 1, wherein the first and second terminals are located in the same plane.
